(19) United States
(12) Patent Application Publication
(10) Pub. No.: US 2016/0192212 A1
(43) Pub. Date: Jun. 30, 2016

(54) METHOD FOR SENSING MOBILITY LINK QUALITY AND TRANSMITTING DATA IN LOW-POWER WIRELESS NETWORK

(71) Applicant: Electronics and Telecommunications Research Institute, Daejeon (KR)

(72) Inventors: Jeong-Gil KO, Daejeon (KR); Eun-Hee KIM, Daejeon (KR); Nae-Soo KIM, Daejeon (KR); Byung-Bog LEE, Daejeon (KR)

(21) Appl. No.: 14/658,041

(22) Filed: Mar. 13, 2015

(30) Foreign Application Priority Data
Dec. 26, 2014 (KR) 10-2014-0190938

(51) Int. Cl. H04W 24/02

(52) U.S. Cl. CPC H04W 24/02

(57) ABSTRACT

An aspect of the present invention provides a method for sensing a quality of a mobility link by a system for sensing a quality of a mobility link configured for evaluating a quality of a transmission-attempting link connected with a transmission-attempting node: computing link quality metric values of RSSI, LQI and EXT from transmission packets included in the message; computing a distribution ratio of a fuzzy set corresponding to each of the link quality metric values by applying the computed quality metric values to a quality fuzzy set having their respective quality factor indicators configured therein; computing fuzzy estimator values by classifying and aggregating the computed fuzzy distribution ratio of the quality fuzzy set into a first, a second and a third quality; and evaluating a quality of the transmission-attempting link based on the fuzzy estimator values.

### CROSS-REFERENCE TO RELATED APPLICATIONS

This application claims the benefit of Korean Patent Application No. 10-2014-0190938, filed with the Korean Intellectual Property Office on Dec. 26, 2014, the disclosure of which is incorporated herein by reference in its entirety.

### BACKGROUND

1. Technical Field

The present invention relates to a method for sensing a quality of each wireless link under a mobile condition in a low-power wireless network.

2. Background Art

When a node with mobility communicates information by generating a multi-hop network in a low-power wireless network, selecting a next hop becomes important.

The next hop is mainly selected by use of global optimization, which considers the efficiency to the destination node, or local optimization, which considers the efficiency to the first hop. Considering the global optimization increases the overall network efficiency while considering the local optimization allows the mobile node to operate with minimal resources.

The conventionally used method has been based on the Signal-to-Noise Ratio (SNR), but this method, which has been used in mobile communications, may increase the deviation of the intensity of received signals in the low-power wireless network.

Metrics, such as the Expected number of Transmissions (ETX), Link Quality Indicator (LQI), Average RSSI, etc., have their own advantages in a certain range of link or in certain conditions in which the most suitable link quality is measured.

Accordingly, a method for evaluating a mobility link in a wireless networks is needed to efficiently combine and evaluate the aforementioned metrics on a low-power wireless network.

The related art of the present invention is disclosed in Korea Patent Publication No. 10-2013-0036510 (laid open on Apr. 12, 2013).

### SUMMARY

The present invention provides a method for sensing a quality of an available link with mobility that can efficiently combine multiple metrics for evaluating the quality of each wireless link with mobility on a low-power wireless network.

The present invention also provides a method for sensing a quality of a link with mobility that can measure the quality of an available link as a relative indicator by effectively aggregating uncertainties of link quality on a low-power wireless network.

An aspect of the present invention provides a method for sensing a quality of a mobility link by a system for sensing a quality of a mobility link configured for evaluating a quality of a transmission-attempting link connected with a transmission-attempting node by a mobile node based on a message received from the transmission-attempting node, including: computing link quality metric values of a received signal strength indicator (RSSI), link quality indicator (LQI) and expected number of transmissions (EXT) from transmission packets included in the message; computing a distribution ratio of a fuzzy set corresponding to each of the link quality metric values of the RSSI, LQI and ETX by applying the computed quality metric values to a quality fuzzy set having their respective quality factor indicators configured therein; computing fuzzy estimator values by classifying and aggregating the computed fuzzy distribution ratio of the quality fuzzy set into a first quality, a second quality and a third quality; and evaluating a quality of the transmission-attempting link based on at least one of the fuzzy estimator values of the first quality, the second quality and the third quality.

A method according to an embodiment of the present invention can combine and evaluate multiple metrics efficiently on a low-power wireless network having a device mobility.

A method according to an embodiment of the present invention can adaptively vary thresholds when a fuzzy set is configured for RSSI measured from a node having a high mobility on a low-power wireless network.

The embodiments of the present invention can provide a method for sensing a quality of a mobility link that can be effectively applied to various routing layers by effectively classifying multiple link quality states on a low-power wireless network.

### BRIEF DESCRIPTION OF DRAWINGS

FIG. 1 illustrates how multi-hop routing is performed in accordance with an embodiment of the present invention.

FIG. 2. Illustrates how quality fuzzy sets are applied for link quality metrics of mobility links in accordance with an embodiment of the present invention.

FIG. 3 shows how a quality fuzzy set is performed for RSSI in accordance with another embodiment of the present invention.

FIG. 4 shows how the system for sensing a quality of a mobility link in accordance with an embodiment of the present invention interacts with another object.

FIG. 5 illustrates how the system for sensing a quality of a mobility link in accordance with an embodiment of the present invention is embodied in the form of a computer system.

### DETAILED DESCRIPTION

Hereinafter, certain embodiments of a common mode filter and a manufacturing method thereof in accordance with the present invention will be described in detail with reference to the accompanying drawings. In describing the present invention with reference to the accompanying drawings, any identical or corresponding elements will be assigned with same reference numerals, and no redundant description thereof will be provided.

Terms such as “first” and “second” can be used in merely distinguishing one element from other identical or corresponding elements, but the above elements shall not be restricted to the above terms.

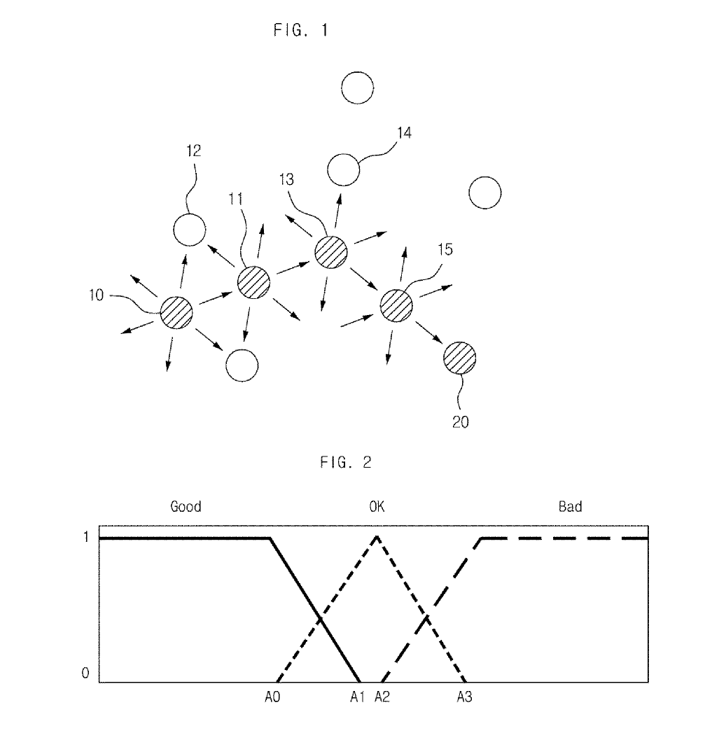

FIG. 1 illustrates how multi-hop routing is performed in accordance with an embodiment of the present invention.

Referring to FIG. 1, a network has a source node 10 having a mobility, neighbor nodes 11, 12, 13, 14, 15 and a destination node 20.

Here, the source node 10 is a node that requests a routing route to the destination node 50.

According to the embodiment shown in FIG. 1, in order to set the routing route to the destination node 20, the source node 10 generates a Route Request (RREQ) message and broadcasts the RREQ message to a neighbor node 11. Upon receiving the RREQ message, the neighbor node 11 re-broadcasts the RREQ message to a nearby neighbor node 13. Through this broadcasting, the destination node 20 receive the RREQ message.

After receiving the RREQ message from the source node 10, the destination node 20 generates a Route Response (RREP) message as a reply to the RREQ message and unicasts the RREP message to the source node 10. For this, identifiers (IDs) of neighbor nodes stored in each node are utilized.

For communication of the RREQ message and the RREP message, a routing route is configured between the source node 10 and the destination node 20.

Here, the RREP message is a message that allows a node that has detected a link disconnection to allow the source node 10 to reconfigure the routing route.

A system for sensing a quality of a mobility link in accordance with an embodiment of the present invention is configured to sense and evaluate signal qualities for various received messages.

Link quality metrics for evaluating the signal qualities of available links include the expected number of transmissions (EXT), link quality indicator (LQI), symbol error rate (SER) and received signal strength indicator (RSSI).

However, these link quality metrics may not indicate the quality uniformly for every condition of the mobility link environment, and may have their own range of link showing advantages or their own conditions in which the most suitable link quality is measured.

The system for sensing a quality of a mobility link in accordance with an embodiment of the present invention uses an uncertainty determination of a fuzzy logic to combine the various link quality metrics and evaluate the combined link quality.

As the fuzzy logic is fundamentally configured to obtain an effective solution when it is uncertain whether a predetermined value is high or low, the present embodiment utilizes the fuzzy logic to use the uncertain characteristics of the link quality metrics that show the quality of mobility links in a low-power wireless network as available indicators.

For example, when a packet having the RSSI of −85 dBm is received, there is no clear basis for determining what the quality of this link is and whether this link is a good link or a bad link.

In addition to the RSSI, other commonly used link quality metrics such as LQI and ETX have similar uncertainties.

In an embodiment of the present invention, each fuzzy set is generated using different quality factor indicators through the fuzzy logic.

FIG. 2. Illustrates how quality fuzzy sets are applied for link quality metrics of mobility links in accordance with an embodiment of the present invention.

Referring to FIG. 2, the X-axis shows fuzzy groups, and the Y-axis a quality distribution.

According to the present embodiment, a quality may be classified into a first quality, a second quality and a third quality by considering some degree of uncertainty for the indicators such as ETX, RSSI, LQI and SER.

In the present embodiment, the first quality, the second quality and the third quality may correspond to “good,” “ok” and “bad,” respectively.

Referring to FIG. 2, A0, A1, A2 and A3 are quality factor indicator points for the link quality metrics.

While the quality distribution is formed in such a way that the first quality is positioned on the left side and the third quality is positioned on the right side, the right side boundary point corresponding to 100% (1) of the first quality is set as the A0 indicator point, and the 0% (0) point of the first quality is set as the A1 indicator point by extending a downwardly slope section on the right side in such a way that a partial section of the first quality from the boundary point (A0) of 100% (1) is overlapped with a section of the second quality.

Moreover, the left side boundary point corresponding to 100% (1) of the third quality is set as the A3 indicator point, and the 0% point of the third quality is set as the A2 indicator point by extending a downwardly slope section on the left side in such a way that a partial section of the third quality from the boundary point (A3) of 100% (1) is overlapped with a section of the second quality.

A halfway point between the A1 indicator point and the A2 indicator point is set as a 100% (1) boundary point of the second quality.

The section downwardly extended to the A1 indicator point from the 100% (1) boundary point of the second quality is overlapped with the first quality, and the quality thereof is evaluated using a fuzzy estimator value, which is a distribution ratio based on its position of distribution.

Moreover, the section downwardly extended to the A3 indicator point from the 100% (1) section of the second quality is overlapped with the third quality, and the quality thereof is evaluated using a fuzzy estimator value, which is a distribution ratio based on its position of distribution.

In the present embodiment, the values of A0, A1, A2 and A3 can be application and channel environment dependent or can be adaptively set according to communication success or failure.

Moreover, the boundary values may be experimentally set using basic hardware characteristics.

According to the present embodiment, the system for sensing a quality of a mobility link senses the quality of a node trying to transmit the message using the quality fuzzy set through the following method for sensing a quality of a mobility link.

The method for sensing a quality of a mobility link includes using a message transmitted and received between a mobile node and the node trying to transmit the message.

Firstly, the link quality metrics, such as RSSI, LQI and ETX, are measured from a transmission packet included in the message.

For instance, the mobile node has received 5 packets from a neighbor node, and an average RSSI is measured to be −65 dBm, and the LQI is measured to be 95. These values may be captured from a communication network.

According to the present embodiment, the ETX may be counted using packet sequence numbers included in a received RREQ packet.

For example, if the packet sequence numbers of [1, 2, 3, 5, 6] are received, it means that the mobile node has transmitted 6 packets and received 5 packets. Therefore, the ETX is computed to be 1.2 (i.e., 6/5).

The fuzzy groups for ETX, RSSI and LQI are activated when they are measured.

Then, by applying the above measured quality metric values to the quality fuzzy set in which each quality factor indicator is set, a distribution ratio of the fuzzy set corresponding to each of the RSSI, LQI and ETX is computed.

In the present embodiment, the ETX of the mobile node, which is currently moving, is set to be 1.1, 1.3, 1.8 and 3.0 for A0, A1, A2 and A3, respectively. Since the above computed ETX of the current link is 1.2, the link quality metric value of the mobile node is between A0 and A1.

Since 1.2 is exactly a middle value between A0 and A1 in the present embodiment, the fuzzy estimator value is outputted as “50% good and 50% ok.”

Moreover, in the present embodiment, the RSSI of the mobile node is set to be −65 dBm, −90 dBm, −98 dBm and −100 dBm for A0, A1, A2 and A3, respectively. By applying the average RSSI of −65 dBm for the current link to the above fuzzy group, the fuzzy estimator value is outputted as “100% good.”

Moreover, in the present embodiment, the LQI of the mobile node is set to be 100, 80, 70 and 50 for A0, A1, A2 and A3, respectively.

In such a case, the LQI of the link included in the mobile node is shown to be 95, and thus the LQI fuzzy estimator value is outputted as “75% good and 25% ok.”

Next, the computed fuzzy distribution ratios of the fuzzy set are grouped into the first quality, the second quality and the third quality and aggregated to compute the fuzzy estimator value.

According to the present embodiment, the fuzzy estimator value with the aggregated metric values computed above has 225% good, 75% ok, and 0% bad.

Then, the quality of the link attempting to transmit the message is estimated using the fuzzy estimator value of at least one of the computed first quality, second quality and third quality.

Therefore, in the present embodiment, it can be said that the link to which the mobile node belongs is included in the first quality (i.e., good).

Moreover, it is possible to suggest the link quality as the first quality by configuring a count value from a suggested value as a data transmission link from a past track history and determining whether the fuzzy estimator value belonging to the first quality is greater than the configured count value.

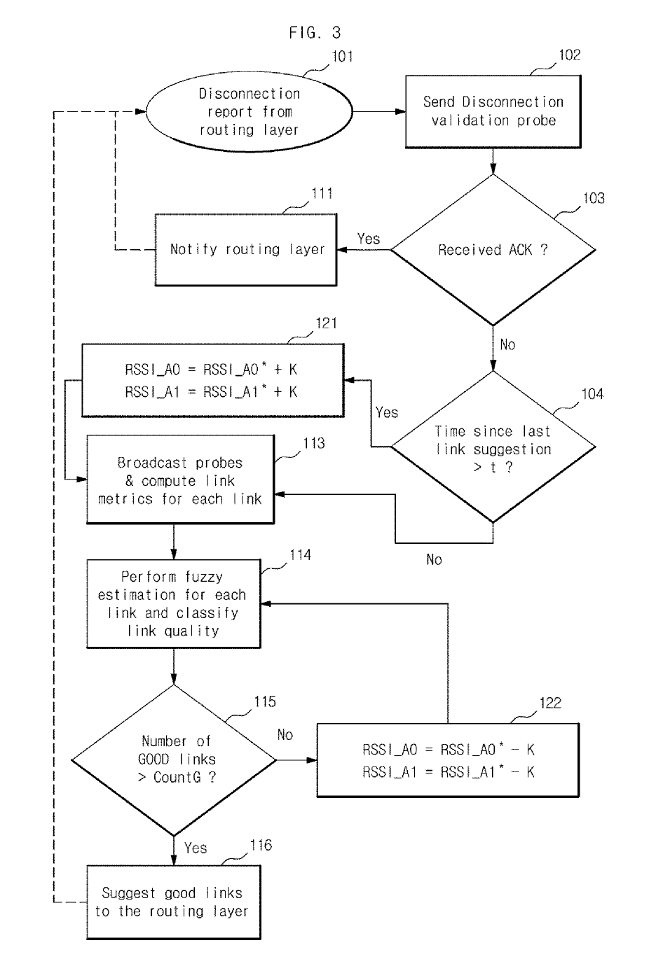

FIG. 3 shows how the system for sensing a quality of a mobility link in accordance with an embodiment of the present invention performs a quality fuzzy set for RSSI.

According to an embodiment of the present invention, for the RSSI measured from a node having a high mobility, the quality factor indicator points of A0, A1, A2 and A3 for each fuzzy set may be configured based on the method shown in FIG. 3.

In step 101, a transceiver of the system for sensing a quality of mobility link in accordance with an embodiment of the present invention receives a disconnection report from a routing layer.

Then, in step 102, the transceiver of the system for sensing a quality of mobility link sends the received disconnection report to a validity probe in the system for sensing a quality of mobility link.

Next, in step 103, the validity probe having received the disconnection report determines whether an acknowledgment (ACK) message is received from a node that has attempted transmission (hence “transmission-attempting node” hereinafter).

If it is determined by the validity probe that the ACK message is received from the transmission-attempting node in step 103, the routing layer is notified in step 111 that the ACK message is received.

If it is determined by the validity probe that the ACK message is not received from the transmission-attempting node in step 103, it is determined in step 104 whether the time since last link suggestion has exceeded a predetermined time (t).

If it is determined in step 104 that the time since last link suggestion has exceeded the predetermined time (t), step 121 is carried out to configure new thresholds A0 and A1 by adding a additional variable to last quality factor indicators A0* and A1* according to the following equation.

RSSI_A0=RSSI_A0*+K, RSSI_A1=RSSI_A1*+K

where K is a additional variable for having a predetermined amount of buffer and may be between 3 dBm and 10 dBm in the present embodiment. In a preferable embodiment, K is set as 5 dBm in order to compute a reliable value for the RSSI measured from a node having a high mobility.

In other words, if it is determined that the ACK message has not been received from the transmission-attempting node, the last quality estimation is determined to be incorrect, and a boundary value of the first link is set higher.

In step 113, the newly configured quality factor indicators A0 and A1 are sent to broadcast probes and compute link metrics of the system for sensing a quality of a mobility link.

If it is determined in step 104 that the time since last link suggestion has not exceeded the predetermined time (t), step 113 is carried out to send the link's received metric values to the broadcast probes and compute link metrics of the system for sensing a quality of a mobility link.

In step 114, the compute link metrics of the system for sensing a quality of a mobility link perform fuzzy estimation by substituting the received metric values in order to classify the link quality of the link connected to the transmission-attempting node in accordance with the embodiment shown in FIG. 2.

Based on the result of performing fuzzy estimation in step 114, the system for sensing a quality of a mobility link determines in step 115 whether the number of first quality (good) links is greater than a predetermined count G.

In another embodiment of the present invention, the step of evaluating the quality of the link attempting to transmit the message may be carried out by including the processes following step 115.

If it is determined in step 115 that the number of first quality (good) links is not greater than the predetermined count G, the system for sensing a quality of a mobility link configures new thresholds A0 and A1 by subtracting a additional variable from last quality factor indicators A0* and A1* according to the following equation.

RSSI_A0=RSSI_A0−K, RSSI_A1=RSSI_A1−K

where K is a additional variable for having a predetermined amount of buffer and may be set as 5 dBm in the present embodiment.

The quality factor indicators configured in step 122 are fed back to step 114 to performs fuzzy estimation again.

If it is determined in step 115 that the number of first quality (good) links is greater than the predetermined count G, the system for sensing a quality of a mobility link suggests the link having the transmission-attempting node included therein as the first quality (good) link to the routing layer.

FIG. 3 shows how the system for sensing a quality of a mobility link finds proper thresholds of the quality factor indicators that are suitable for a communication environment of a mobility link. By measuring the qualities of the thresholds and modifying the thresholds to proper thresholds according to FIG. 3, the system for sensing a quality of a mobility link in accordance with the present embodiment may adjust the indicator points of the fuzzy sets shown in FIG. 2 in a preferable direction.

In the present embodiment, after the fuzzy thresholds are set based on the quality factor indicators for the link metrics, a probability is calculated to determine what percentage of each link metric belongs to which fuzzy set.

In the present embodiment, the calculated probability is added to select a most probable set among the good, ok and bad sets and to suggest the selected most probable set as the link quality.

The present embodiment may be effective for the routing protocols that are widely used for networking, by presenting a method for classifying the mobile nodes as good, bad or ok links.

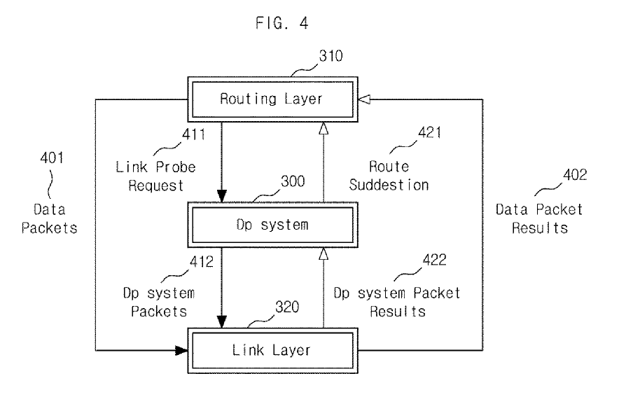

FIG. 4 shows how the system for sensing a quality of a mobility link in accordance with an embodiment of the present invention is applied for data communication with another object.

Referring to FIG. 4, a system 300 for sensing a quality of a mobility link in accordance with an embodiment of the present invention receives a link request from a routing layer 310 in step 411.

The system 300 for sensing a quality of a mobility link sends system packets to a link layer 320 in step 412.

In the present embodiment, the system packets include information that feeds back the history of what has happened in the layer, for example, whether the packets were successfully transmitted, how many time the packets were retransmitted if the packet transmission was successful, etc.

The link layer 320 having received the system packets sends a system packet result to the system 300 for sensing a quality of a mobility link in step 422.

The system 300 for sensing a quality of a mobility link having received the system packet result sends a route suggestion to the routing layer 310 in step 421.

In step 410, the routing layer 310 sends data packets to the link layer 320 through the suggested route links.

Thereafter, the link layer 320 having received the data packets sends the data packet result to the routing layer 310 in step 402.

The system for sensing a quality of a mobility link in accordance with the embodiment shown in FIG. 4 may increase the rate of successful data packet transmission by sensing and suggesting good links as the route.

The method according to an embodiment of the present invention can efficiently combine and evaluate multiple metrics on a low-power wireless network.

The method according to an embodiment of the present invention can adaptively vary the thresholds of the quality factor indicators when the fuzzy set is configured for the RSSI measured from a node having a high mobility.

The embodiments of the present invention can be effectively applied to various routing layers by effectively classifying multiple link quality states.

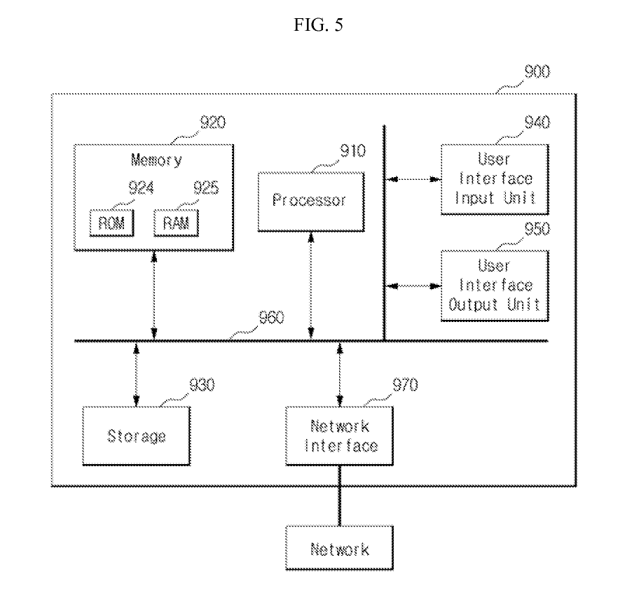

FIG. 5 illustrates how the system for sensing a quality of a mobility link in accordance with an embodiment of the present invention is embodied in the form of a computer system.

The above-described a system for sensing a quality of a mobility link 300 may be implemented in a computer system, e.g., as a computer readable medium. As shown in in FIG. 5, a computer system 900 may include one or more of a processor 910, a memory 920, a user interface input unit 940, a user interface output unit 950, and a storage 930, each of which communicates through a bus 960. The computer system 900 may also include a network interface 970 that is coupled to a network. The processor 910 may be a central processing unit (CPU) or a semiconductor device that executes processing instructions stored in the memory 920 and/or the storage 930. The memory 920 and the storage 930 may include various forms of volatile or non-volatile storage media. For example, the memory may include a read-only memory (ROM) 924 and a random access memory (RAM) 925.

What is claimed is:

1. A method for sensing a quality of a mobility link by a system for sensing a quality of a mobility link configured for evaluating a quality of a transmission-attempting link connected with a transmission-attempting node by a mobile node based on a message received from the transmission-attempting node, the method comprising:
computing link quality metric values of a received signal strength indicator (RSSI), link quality indicator (LQI) and expected number of transmissions (EXT) from transmission packets included in the message;
computing a distribution ratio of a fuzzy set corresponding to each of the link quality metric values of the RSSI, LQI and ETX by applying the computed quality metric values to a quality fuzzy set having their respective quality factor indicators configured therein;
computing fuzzy estimator values by classifying and aggregating the computed fuzzy distribution ratio of the quality fuzzy set into a first quality, a second quality and a third quality; and
evaluating a quality of the transmission-attempting link based on at least one of the fuzzy estimator values of the first quality, the second quality and the third quality.

2. The method of claim 1, wherein, in the computing of the link quality metric values, the link quality metric value of the ETX is computed using a packet sequence number included in the transmission packets.

3. The method of claim 1, wherein in the computing of the fuzzy estimator values, the first quality, the second quality and the third quality refer to good, ok and bad, respectively, and boundary values of the quality factor indicators in the quality fuzzy set are configured by feeding back a past history.

4. The method of claim 1, wherein, in the evaluating of the quality of the transmission-attempting link, the quality of the link is evaluated as a first quality link by configuring a count value from a suggested value as a data transmission link from a past track history and determining whether the fuzzy estimator value belonging to the first quality is greater than the configured count value.

5. The method of claim 1, wherein an X-axis of the quality fuzzy set refers to a fuzzy group and a Y-axis thereof refers to a quality distribution,
wherein the X-axis have a plurality of quality factor indicator points configured thereon for identifying a distribution of each quality, and the fuzzy group has the first quality distributed on a left side thereof, the third quality distributed on a right side thereof and the second quality distributed in a middle thereof,
wherein an A0 indicator point is set at a lower side X-axis boundary point corresponding to a 100% distribution of the first quality,
wherein an A1 indicator point is set on a right side of the A0 indicator point corresponding to a 0% distribution point of the first quality by extending a downwardly slope section on the right side thereof in such a way that a partial distribution section of the first quality from an upper 100% of the A0 indicator point is overlapped with a distribution section of the second quality, and
wherein an A3 indictor point is set at a lower side X-axis boundary point corresponding to a 100% distribution of the third quality, and an A2 indicator point corresponding to 0% of the third quality is set on a left side of the A3 indicator point by extending a downwardly slope section on the left side thereof in such a way that a partial distribution section of the third quality is overlapped with a section of the second quality.

6. The method of claim 5, wherein a point of the quality factor indicator points where the second quality is 100% distributed is set in a middle of the A1 and A2 indicator points, and the A0 and A3 indicator points are set as indicator points where the second quality is 0% distributed, and a section from the point where the second quality is 100% distributed to the A0 and A1 indicator points is set as a section in which the second quality is distributed.

7. The method of claim 5, wherein the computing of the distribution ratio corresponding to the link quality metric value of the RSSI from the quality fuzzy set comprises:
having the system for sensing a quality of a mobility link determine whether an ACK message is received from the transmission-attempting node;
determining whether the time since last link suggestion has exceeded a predetermined time (t) if it is determined by the system for sensing a quality of a mobility link that the ACK message is not received;
modifying and setting A0 and A1 as new thresholds by adding a additional variable to last quality factor indicators A0* and A1* according to the following equation if it is determined that the time since last link suggestion has exceeded the predetermined time (t)
RSSI_A0=RSSI_A0*+K dbm, RSSI_A1=RSSI_A1*+K
where K is a additional variable for having a predetermined amount of buffer;
sending the modified new quality factor indicators A0 and A1 to a compute link metrics of the system for sensing a quality of a mobility link; and
having the compute link metrics of the system for sensing a quality of a mobility link compute a distribution ratio of the quality fuzzy set by applying the received new quality factor indicator values A0 and A1.

8. The method of claim 5, wherein the evaluating of the quality of the transmission-attempting link comprises:
having the system for sensing a quality of a mobility link determine whether the number of first quality links of the fuzzy estimator value is greater than a predetermined count value from a result of fuzzy estimation;
modifying and setting A0 and A1 as new thresholds by subtracting a additional variable from last quality factor indicators A0* and A1* according to the following equation if it is determined that the number of first quality links is not greater than the predetermined count value;
RSSI_A0=RSSI_A0*−K, RSSI_A1*=RSSI_A1−K
where K is a additional variable for having a predetermined amount of buffer; and
computing the distribution ratio of the quality fuzzy set again by repeating the step of computing a distribution ratio of a fuzzy set corresponding to each of the link quality metric values of the RSSI, LQI and ETX by applying the computed quality metric values to a quality fuzzy set having their respective quality factor indicators configured therein based on the modified quality factor indicators.

9. The method of claim 7, wherein the additional variable is between 3 dBm and 10 dBm.

10. A method of transmitting data between a link layer and a routing layer using the method of sensing a quality of a mobility link in accordance with claim 1, comprising: having the system for sensing a quality of a mobility link having received a link request send system packets to the link layer;
having the link layer having received the system packets send a result message of the system packets to the system for sensing a quality of a mobility link;
having the system for sensing a quality of a mobility link having received the result message of the system packets send a route suggestion to the routing layer based on a result of evaluating the link quality;
having the routing layer send data packets to the link layer through links of the route suggestion; and
having the link layer having received the data packets send a result message of the data packets to the routing layer.
